(19) United States
(12) Patent Application Publication
(10) Pub. No.: US 2017/0328619 A1
(43) Pub. Date: Nov. 16, 2017

(54) OIL REFILL CONTAINER

(71) Applicant: Brain Bee S.p.A., Parma (IT)

(72) Inventor: Andrea CANTADORI, Parma (IT)

(21) Appl. No.: 15/594,580

(22) Filed: May 13, 2017

(30) Foreign Application Priority Data
May 13, 2016 (IT) 102016000049616

(51) Int. Cl. F25B 45/00; B60H 1/00; F16N 19/00

(52) U.S. Cl. CPC F25B 45/00; F16N 19/00; B60H 1/00585; F16N 2210/10; F16N 2210/04

(57) ABSTRACT

An oil refill container that can be coupled to a coolant refill station in an air conditioning system for motor vehicles comprises a body defining an oil containment compartment adapted to be mixed with the coolant circulating in said air conditioning system, and a closing cap provided with quick coupling means adapted to be connected to the refill station or a seat adapted to removably connect the quick coupling means to said closing cap, said closing cap comprising a cover and an under-cap adapted to define a compartment suitable for containing at least an amount of a drying substance when coupled to the cover.

The present invention relates to the field of coolant refill systems in air conditioning and/or climate control systems for motor vehicles.

In particular, the present invention relates to the operation of introducing lubricating oil into the cooling circuit of the air conditioner system and adapted to maintain the various devices or components of said cooling circuit lubricated.

The introduction of oil is an operation that normally precedes the coolant refill operation.

### PRIOR ART

It is known that lubricating oils used in this field are characterized by a high hygroscopicity; it follows that at each oil suction from the respective refill container/tank present in the refill station, the remaining oil inside the tank itself can absorb, and on an average this happens, a certain amount of humidity from the air which replaces the oil ejected and that is then present in the remaining volume inside the container or tank.

The presence of humidity in the lubrication oil damages the subsequent refills of the vehicle cooling circuits; in fact, the particles/traces of water entering into the system may react chemically (under conditions of high temperature and pressure) with the coolant, thereby creating harmful and corrosive acids for the circuit.

An example of a container containing lubricant for use in a refill system for an air conditioning system is described in WO2011/041874.

### SUMMARY OF THE INVENTION

An object of the present invention is to provide an oil refill container comprising a dehydrating cap having the function of allowing the lubricant oil refill while preserving the quality thereof over time, with a simple, rational and cost-effective solution.

A further object is to provide an oil refill container containing drying material which can be associated in a quick and simple manner to a coolant refill station in an air conditioning system for motor vehicles. These and other objects are achieved with the features of the invention described in the independent claim 1. The dependent claims describe preferred and/or particularly advantageous aspects of the invention.

An embodiment of the present invention provides an oil container, comprising a body, also called bottle, which can be sealed hermetically with a closing cap, wherein the closing cap comprises a cover structured so as to cooperate with an under-cap in turn adapted to contain drying substances or means, that is to say, adapted to limit the contamination of the oil by the humidity of the air.

In other words, the closing cap comprises a cover and an under-cap. Preferably, the under-cap is coupled to the cover in a position below it.

According to one aspect of the invention, the closing cap is provided with a quick coupling device arranged to be connected to the refill station, or is provided with a seat adapted to removably connect the coupling means to the closing cap.

Preferably, the quick coupling device is in fluid communication with the containment compartment of the container body.

Preferably, the quick coupling device comprises a tubular connector arranged to be connected to the refill station, the tubular connector being integral with the cover or being adapted to be removably connected to the cover seat.

The under-cap is adapted to define a compartment suitable for containing at least an amount of a drying substance when it is coupled with said cover. In other words, the under-cap is shaped in such a way as to delimit, with the cover, a compartment suitable for containing at least an amount of a drying substance.

The provision of retaining the drying substance by means of the under-cap allows optimizing the space available inside the container body. Moreover, unlike the container described in WO2011/041874, the container according to the invention does not require replacement of a part thereof for its connection to a refill station.

In more detail, the term drying means the chemical-physical process by which water vapor is extracted from the air in an adsorption operation, and where the water vapor molecules bind to the surface of said material, which in a preferred aspect is silica gel or colloidal silica, formally (SiO2)n, a silicon dioxide polymer.

According to one aspect of the invention, the body cooperates in closure with the under-cap and the latter with the cover itself.

Preferably, the hermetic seal between the cover and the under-cap and body takes place by means of sealing rings, such as O-rings, made of plastics and created with the under-cap geometry.

More in general, the container may comprise sealing elements created with the geometry of the under-cap and placed in such a way that a tight seal is created between cover, under-cap and body.

Furthermore, a further O-ring, better described hereinafter and made, for example, of neoprene, is intended to brake the cover by packing it with the under-cap so as to facilitate the unscrewing of the cap with the under-cap, i.e. the closing cap, for filling the body itself. In other words, the closing cap comprises a sealing ring external to the under-cap, said sealing ring being placed between the cover and the under-cap and being configured to restrain the cover and under-cap assembly by friction with such elements.

According to one aspect of the invention, the assembly formed by “body, cap, and under-cap” when assembled can be associated to the air conditioning station, i.e. to the refill station, via the quick coupling device, also known as quick coupling. Said quick coupling is also connected with at least one oil suction device.

According to one aspect of the invention, the container comprises the oil suction device. Preferably, the oil suction device is associated with the closing cap, more preferably the cover, and in fluid communication with the quick coupling device.

According to one aspect of the invention, the under-cap has an opening adapted to receive the suction device.

According to one aspect of the invention, the oil suction device is shaped as a tubular element extending axially from the closing cap, preferably from the cover, to the inside of the containment compartment of the container body.

According to one aspect of the invention, the tubular element forming the suction device is coaxial and in fluid communication with the tubular connector of the quick coupling device.

Preferably, the cover comprises a sleeve adapted to firmly engage the tubular element forming the suction device.

Further sealing systems may be associated with said quick coupling and/or suction device, so as to prevent the passage of air between said cover and said suction device.

According to a further aspect of the invention, said under-cap is a container element or enclosure of rigid material, containing therein the air humidity absorbent material, preferably said adsorbent material is housed within a relative compartment.

According to a further aspect of the invention, the quick coupling device is provided with a sealed check valve which preserves the oil inside the container body. Preferably, the cover, associated with the under-cap, is provided with at least one sealed check valve which preserves the oil inside the container body. The sealed check valve opens only when the body is connected to the system to be refilled and the suction step has started. In other words, the sealed check valve allows the passage of the air only to the inside of the body, replacing the ejected oil, when the container body and the system to be refilled are integrally associated as said above.

According to a further aspect of the invention, the under-cap comprises one or more through holes formed towards the interior of the body (in assembled configuration). These holes allow the passage in both directions of the internal air, which can thus be dried by the substance contained in the under-cap.

In a first embodiment, the under-cap is partly associated with the body by means of a first threaded portion and partly to the cover by means of a second threaded portion.

In a further embodiment, not shown, said under-cap is associable with the cover of the container, but now said cover is directly screwable on a corresponding thread of the body containing the oil.

In essence, the under-cap is a containment body, an accessory, which can be inserted between said container body and the respective cover, containing a compartment for housing the air drying means inside the bottle.

Preferably, said drying means are contained in silica gel bags or enclosures.

The invention also relates to a cartridge or enclosure containing drying material adsorbing the air humidity, i.e. adapted to absorb the air humidity. The cartridge, or enclosure, is configured to be contained in compartment of the above closing cap.

The invention also relates to a closing cap associable to a container associable to a coolant refill station of an air conditioning system for motor vehicles. The closing cap is provided with a quick coupling device adapted to be connected to the refill station or a seat adapted to removably connect the coupling means to the closing cap, the closing cap comprising a cover and an under-cap.

The under-cap is adapted to define a compartment suitable for containing at least an amount of a drying substance when it is coupled with the cover.

Said objects and advantages are all achieved by the oil refill container object of the present invention, which is characterized by the following claims.

### BRIEF DESCRIPTION OF THE FIGURES

This and other features will become more apparent from the following description of some of the configurations, illustrated purely by way of example in the accompanying drawings.

FIG. 1 shows a perspective view of the container with closing cap according to the invention,

FIG. 2: shows the container and a median section thereof,

FIG. 3 shows the detail of the cover and under-cap of said container,

FIG. 4: shows a median and perspective section of the assembly formed by the container body and the closing cap,

FIG. 5: shows the operation of a valve associated with the closing cap to allow the air intake during the oil suction step.

### DESCRIPTION OF THE INVENTION

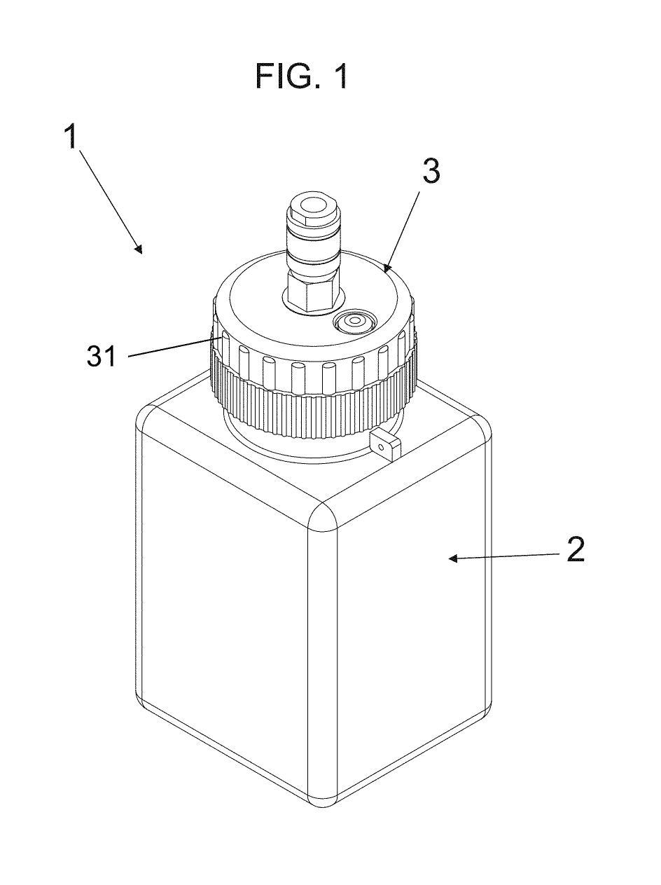

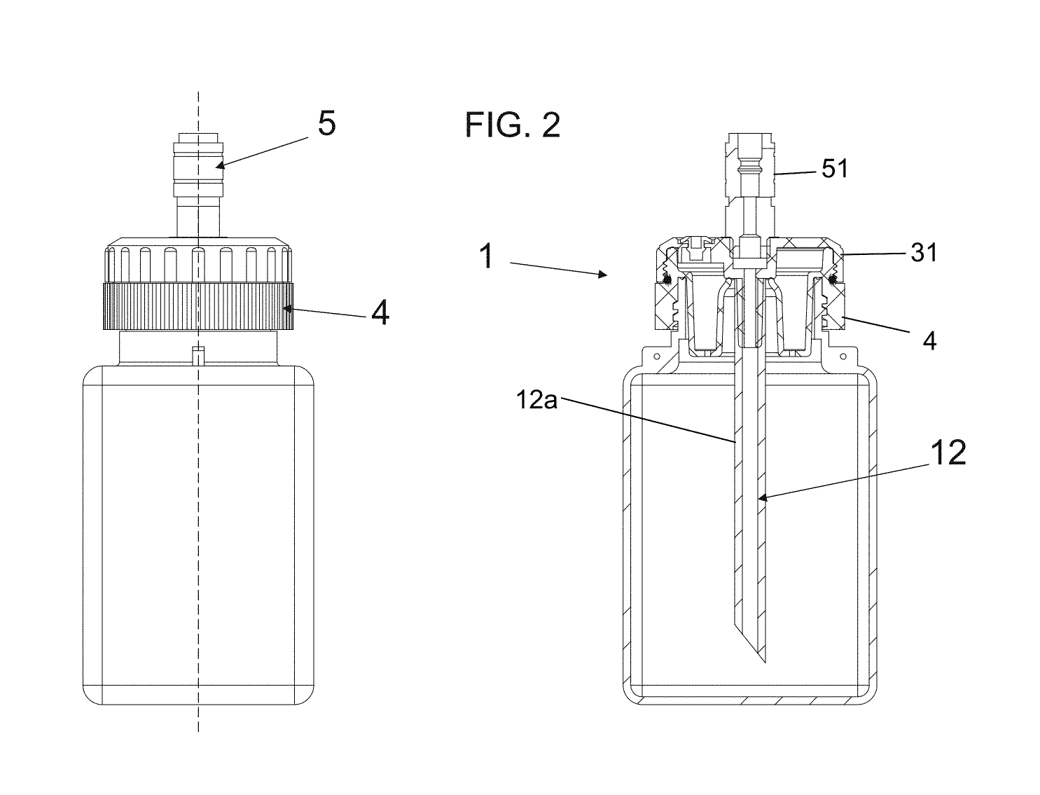

With particular reference to FIG. 1, reference numeral 1 indicates as a whole an oil refill container object of the present invention.

Container 1 can be coupled to a coolant refill station (not shown) in an air conditioning system for motor vehicles.

Container 1 comprises an oil containment body 2 for the containment of oil adapted to be mixed with the coolant circulating in said air conditioning system and a closing cap 3 for closing body 2, preferably by screwing.

A quick coupling device 5 is associated, axially arranged, with said closing cap 3, and an oil suction device 12 is associated, inside body 2, with said closing cap 3; in particular, the quick coupling device is configured for the connection with said refill station.

With reference to the figures, the quick coupling device 5 comprises a tubular connector 51 adapted to be connected to the refill station. The oil suction device 12 is made in the shape of a tubular element 12a extending axially from cover 31 up to within the containment compartment. It should be noted that the tubular element 12a is coaxial and in fluid communication with the tubular connector 51.

The closing cap 3 comprises a cover 31. Between said body 2 and cover 31 there is a rigid enclosure. Preferably, said rigid enclosure is located below the cover and is defined as under-cap 4.

In other words, the closing cap 3 comprises cover 31 and the under-cap 4 coupled to cover 31 in a position below it.

Once cover 31 is associated with under-cap 4, due the conformation of said enclosure (which protrudes towards the container body 2 once assembled), as an inner compartment 7 is defined which can accommodate at least one drying substance or material.

The under-cap 4 is therefore shaped in such a way as to define, with cover 31, a compartment 7 suitable for containing at least an amount of a drying substance.

The function of the drying material is to dry the air inside body 2, which replaces the ejected oil (suctioned by the refill station connected thereto) and which is present in the remaining inner volume of container 1.

In order to allow the air intake, one or more valves 6 are provided, arranged and configured to allow the air passage inside the container, in replacement of the ejected oil.

Said one or more valves 6 are advantageously arranged in the closing cap, outer portion, in assembled configuration of the container.

As said, when vacuum is made in the system, the oil is suctioned through the quick coupling device 5, also known as quick coupling: at this moment, by differential pressure, valve 6 opens, allowing air to enter and let the oil go out.

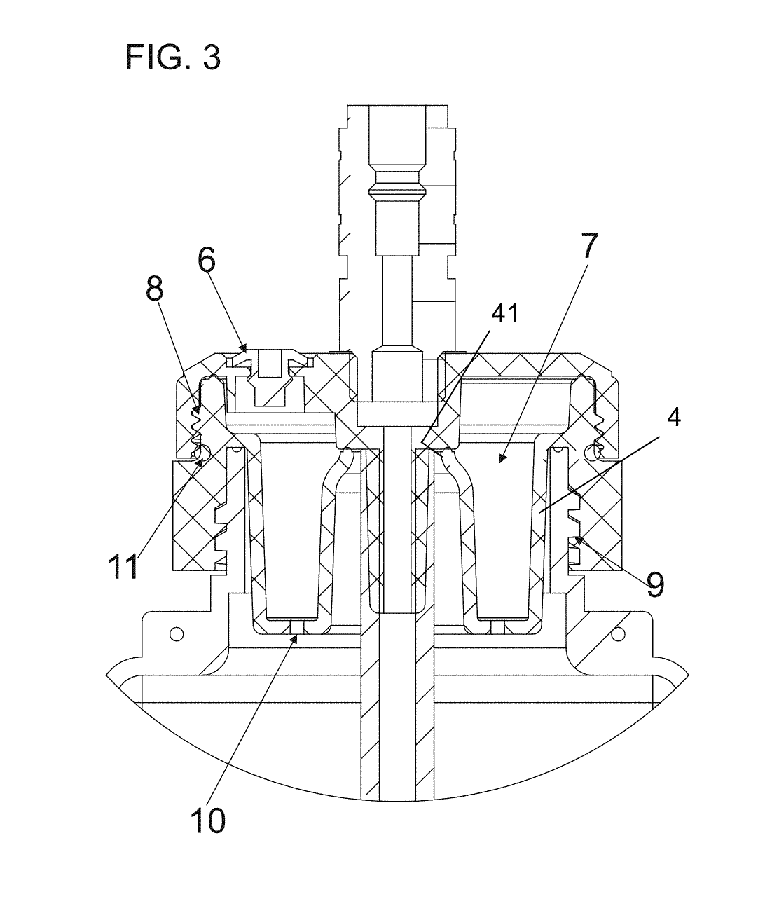

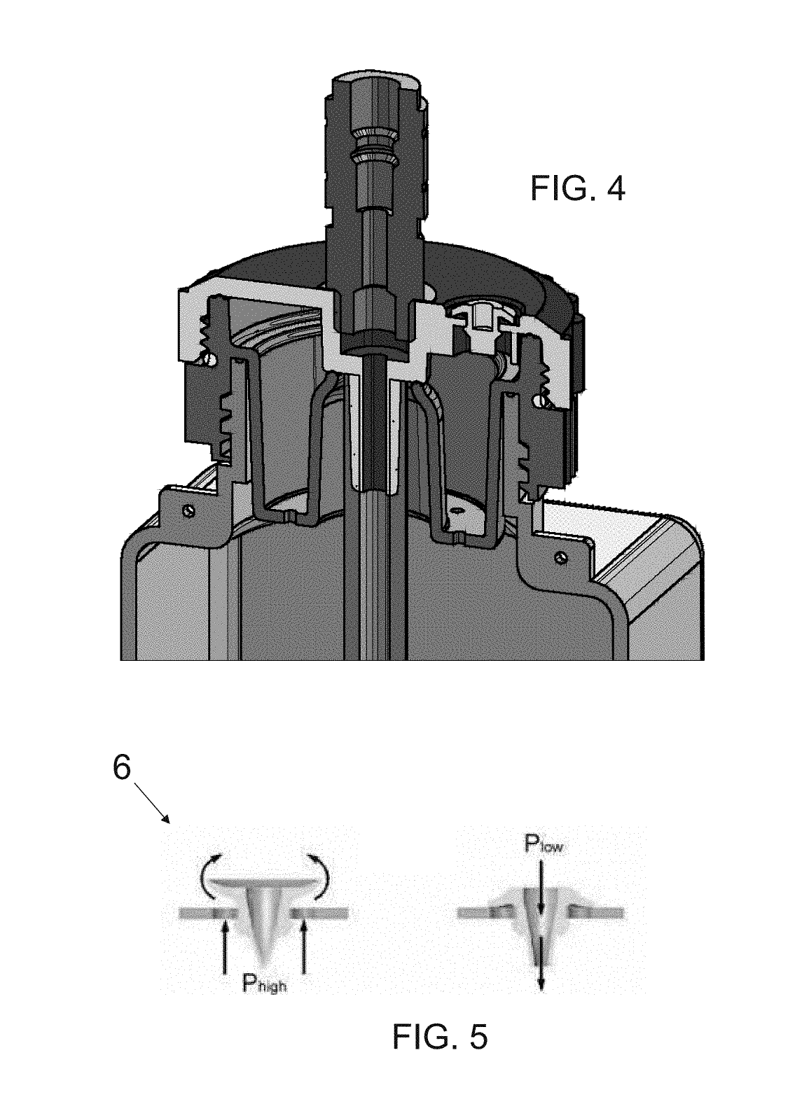

The air passing through compartment 7 containing the drying substance is dehydrated to preserve the oil. The air replaces the oil by means of suitable passage holes 10 and allows the rising of the oil itself through the suction device 12, also known as draft. Said holes 10 are preferably arranged in the under-cap, as shown in FIG. 3, on the body side, in a configuration of container coupled to the closing cap 3.

With reference to the suction device 12, it is provided with an air sealing system, precisely on cover 31, on the side facing towards the refill station.

Container 1 is adapted to be filled with 250 cc of oil suitable for the specific system that is being refilled (PAG or POE).

According to the foregoing, container 1 can be hermetically closed and/or sealed by means of the aforementioned cover 31 and under-cap 4 containing a drying material, preferably contained in a breathable bag or enclosure; preferably, said drying material is silica-gel. The hermetic seal between cover 31, under-cap 4 and container 2 is obtained by means of O-rings having geometry of the under-cap 4.

It should be noticed the presence of a sealing 11, outer O-ring. Preferably, said sealing ring is of neoprene. With this solution, the sealing ring brakes cover 31 by packing it with the under-cap 4 so as to facilitate the loosening of the assembly formed by cover 31 and the relative under-cap 4 for filling body 2 of container 1.

The quick coupling is provided with a sealed check valve which preserves the oil the bottle, the sealed check valve opens only when the body is connected to the system to be filled. In the event of malfunction or in any case, in the event that a higher pressure than the ambient one is created inside body 2, the sealed check valve is configured to open thereby allowing the pressure rebalancing inside the bottle itself.

Said under-cap 4 has an opening 41 adapted to receive said suction device 12.

With reference to the figures, the tubular element 12a is axially extended from cover 31 up to the inside of the containment compartment through opening 41.

Said under-cap 4 is directly associable to cover 31 and said cover 31 is directly screwable on the corresponding thread of body 2 containing the oil. Alternatively, said under-cap 4 is associable to both body 2 of container 1, by at least a first threaded portion 9, and to cover 31, by a second threaded portion 8.

The following are also protected:
separate cartridge or enclosure, containing drying material adsorbing the air humidity (i.e. adapted to absorb the air humidity), associable to a closing cap of an oil to a cap of a container of oil refill container, said container couplable to a coolant refill station of an air conditioning system for motor vehicles.
the closing cap, comprising a cover and an under-cap suitable for containing drying material adsorbing the air humidity; said closing cap associable to a container, the container associable to a coolant refill station of an air conditioning system for motor vehicles.

It is clear that several changes and/or additions of parts may be made to the transfer apparatus and relevant method described herein without departing from the scope of the present invention.

It is also clear that while the present invention has been described with reference to some specific examples, a man skilled in the art can certainly implement many other equivalent embodiments of the transfer apparatus and relevant method, having the features set forth in the claims, and thus all falling within the scope of protection defined by them.

1. An oil refill container, configured for coupling to a coolant refill station in an air conditioning system for motor vehicles, the container comprising:
a body defining an oil containment compartment adapted to be mixed with a coolant circulating in an air conditioning system, and
a closing cap provided with a quick coupling device adapted to be connected to the refill station, or provided with a seat adapted to removably connect the coupling device to the closing cap, the closing cap comprising a cover and an under-cap, wherein the under-cap is adapted to define a compartment suitable for containing at least an amount of a drying substance when the under-cap is coupled with the cover.

2. The container according to claim 1, further comprising one or more sealing elements configured with a shape corresponding to geometry of the under-cap and placed in the container such a way that a tight seal is created between cover, under-cap and body.

3. The container according to claim 2, wherein said sealing elements are plastic O-rings.

4. The container according to claim 1, wherein the closing cap comprises a sealing ring external to the under-cap, the sealing ring being placed between the cover and the under-cap and being configured to restrain the cover and under-cap assembly by friction.

5. The container according to claim 1, wherein the closing cap comprises a valve configured to open by pressure difference and let air in to release oil, wherein the air takes the place of the oil through dedicated passage holes in the under-cap and allows ascent of the oil through said closing cap.

6. The container according to claim 1, further comprising an oil suction device associated with the cover and in fluid communication with the quick coupling device.

7. The container, according to claim 6, wherein the under-cap has an opening adapted to house the suction device.

8. The container according to claim 6, wherein the oil suction device is in the shape of a tubular element extending axially from the cover up to within the containment compartment.

9. The container according to claim 8, wherein the tubular element forming the suction device is coaxial and in fluid communication with a tubular connector in the quick coupling device.

10. The container according to claim 1, wherein the quick coupling device is provided with a sealed check valve that preserves the oil within the body, the sealed check valve being configured to open only when the body is connected to a system to be filled.

11. The container according to claim 1, wherein the under-cap is directly associable to the cover and the cover is directly screwable on a corresponding thread of the container body.

12. The container according to claim 1, wherein the under-cap is associable to both the container body, by at least a first threaded portion, and to the cover, by a second threaded portion.

13. The container according to claim 6, comprising an air sealing system arranged between the cover and the suction device.

14. A cartridge containing drying material adapted to absorb air humidity, and shaped to be contained in a compartment closed by a closing cap according to claim 1.

15. A closing cap associable to a container configured for coupling to a coolant refill station in an air conditioning system for motor vehicles, the closing cap comprising a cover and an under-cap which is adapted to define a compartment suitable for containing at least an amount of a drying substance when the under-cap is coupled with the cover;
wherein the closing cap is provided with a quick coupling device adapted to be connected to the refill station or is provided with a seat adapted to removably connect said coupling device to the closing cap.
